(19) United States
(12) Patent Application Publication
(10) Pub. No.: US 2024/0113562 A1
(43) Pub. Date: Apr. 4, 2024

(54) INDUCTIVE POWER SUPPLY BACKPACKS FOR INDUCTIVELY POWERED POWER TOOLS

(71) Applicant: Milwaukee Electric Tool Corporation, Brookfield, WI (US)

(72) Inventors: Beth E. Cholst, Wauwatosa, WI (US); Dominick Ropella, Brookfield, WI (US)

(21) Appl. No.: 18/472,989

(22) Filed: Sep. 22, 2023

Related U.S. Application Data
(60) Provisional application No. 63/411,280, filed on Sep. 29, 2022.

(51) Int. Cl. H02J 50/10; B25F 5/02

(52) U.S. Cl. CPC H02J 50/10; B25F 5/02; H02J 50/90

(57) ABSTRACT

Inductively powered power tool systems are provided. An inductively powered power tool system includes an inductive power supply backpack comprising a power source; a power transmitter system configured to inductively transfer power from the power source via a transmittal coil; and a wearable transmitter, wherein the wearable transmitter comprises the transmittal coil. The inductively powered power tool system further includes an inductively powered power tool comprising a power receiver system configured to inductively receive power from the power transmitter system; a working implement; and a drive unit, configured to drive the working implement using power inductively received by the power receiver system from the power transmitter system.

### CROSS-REFERENCE TO RELATED APPLICATIONS

The present application claims priority to U.S. Provisional Patent Application No. 63/411,280 filed on Sep. 29, 2022, the disclosure of which is incorporated by reference herein in its entirety.

### FIELD

The present disclosure relates generally to power tools, and more particularly to powering power tools using inductive power.

### BACKGROUND

Power tools are generally utilized in lieu of hand tools. Power tools can perform the same, or similar, tasks as hand tools at higher efficiency, allowing the operator controlling the power tool to use less effort in achieving a task. For example, powered hedge trimmers can trim foliage faster than traditional yard shears.

Power tools may be powered through a variety of power sources such as gas motors or electric motors onboard the power tool. For electric motors, power may be suppled by plugging the power tool into an electrical outlet, charging a battery built into the power tool, or selectively providing one or more removable batteries for the power tool. In some instances, the same removable battery may be compatible with multiple different power tools. Thus, an operator may selectively provide a rechargeable battery to a first power tool, then, upon completion of an operation, remove the rechargeable battery from the first power tool and provide it to a second power tool. However, the selective engagement and disengagement of power supplies with power tools, whether utilizing removable batteries or electrical outlet connections, requires a manual step for the operator and provides the inclusion of one or more potentially exposed electrical terminals. Moreover, batteries onboard the power tools can add weight to the power tool and impede its overall movement.

Accordingly, improved power tools are desired in the art. In particular, inductively powered power tool systems which provide inductive power to power tools from an inductive power supply backpack via a power glove worn by the operator would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, an inductive power supply backpack is provided. The inductive power supply backpack includes a power source; a power transmitter system configured to inductively transfer power from the power source via a transmittal coil; and a wearable transmitter, wherein the wearable transmitter comprises the transmittal coil.

In accordance with another embodiment, an inductively powered power tool system is provided. The inductively powered power tool system includes an inductive power supply backpack comprising a power source; a power transmitter system configured to inductively transfer power from the power source via a transmittal coil; and a power glove, wherein power glove comprises the transmittal coil. The inductively powered power tool system further includes an inductively powered power tool comprising a power receiver system configured to inductively receive power from the power transmitter system; a working implement; and a drive unit, configured to drive the working implement using power inductively received by the power receiver system from the power transmitter system.

In accordance with another embodiment, an inductively powered power tool system is provided. The inductively powered power tool system includes an inductive power supply backpack comprising a power source; a power transmitter system configured to inductively transfer power from the power source via a transmittal coil; and a power glove, wherein the power glove comprises the transmittal coil. The inductively powered power tool system further includes a plurality of inductively powered power tools, wherein each of the plurality of inductively powered power tools comprises a power receiver system configured to inductively receive power from the power transmitter system; a working implement; and a drive unit, configured to drive the working implement using power inductively received by the power receiver system from the power transmitter system.

In accordance with another embodiment, a method for operating an inductively powered power tool is provided. The method includes wearing an inductive power supply backpack comprising a power source; a power transmitter system configured to inductively transfer power from the power source via a transmittal coil; and a power glove, wherein the power glove comprises the transmittal coil. The method further includes gripping a tool handle of the inductively powered power tool using the power glove; and operating the inductively powered power tool while the tool handle is gripped by the power glove.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is an inductively powered power tool system in accordance with embodiments of the present disclosure;

FIG. 2 is perspective view of an inductively powered power tool in accordance with embodiments of the present disclosure;

FIG. 3 is a perspective view of an inductive power supply backpack in accordance with embodiments of the present disclosure;

FIG. 4 is a top view of a power glove in accordance with embodiments of the present disclosure;

FIG. 5 is a schematic view of inductive coupling between an inductive power supply backpack and an inductively powered power tool in accordance with embodiments of the present disclosure;

FIG. 6A is a top view of a power glove with a transmittal coil in accordance with embodiments of the present disclosure;

FIG. 6B is a perspective view of an inductively powered power tool with a receiver coil for inductively coupling with the power glove of FIG. 6A in accordance with embodiments of the present disclosure;

FIG. 7A is a top view of a power glove with another transmittal coil in accordance with embodiments of the present disclosure;

FIG. 7B is a perspective view of inductively powered power tool with another receiver coil for inductively coupling with the power glove of FIG. 7A in accordance with embodiments of the present disclosure;

FIG. 8 is an inductively powered power tool being magnetically aligned with an inductive power supply backpack in accordance with embodiments of the present disclosure;

FIG. 9 is an inductively powered power tool system with a plurality of compatible inductively powered power tools in accordance with embodiments of the present disclosure; and

FIG. 10 is a method for operating an inductively powered power tool in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “power tool” is intended to refer to a device which is used to perform a work operation, such as trimming objects like branches; cutting materials like wood, metal, concrete, grass, or the like; biasing fluids like air and water; and the like. By way of non-limiting example, power tools can include hedge trimmers, chainsaws, circular saws, reciprocating saws, grinders, pruners, string trimmers, lawnmowers, edgers, blowers, vacuums, snow throwers, mixers, augers, pumps, pipe threaders, drills, and impact wrenches. While certain embodiments provided below are directed to hedge trimmers, one or more different types of power tools may also be realized within the scope of this disclosure.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, inductively powered power tool systems are provided for inductively powering various power tools using an inductive power supply backpack and a wearable transmitter such as a power glove. The inductive power supply backpack includes a power source and a power transmitter system that provides a current to a transmittal coil in and/or on the power glove. One or more inductively powered power tools have a complimentary power receiver system, including a receiver coil in and/or on a handle of the power tool. An operator can thereby wear the inductive power supply backpack and its power glove to provide inductive power to one or more power tools simply by grabbing the handle of the power tools with the power glove.

The inductively powered power tool system enables greater battery capacity for the power tool by putting the battery load on the operators back instead of on a power tool that gets carried by hand. Moreover, the inductive coupling provides a power connection using sealed individual components that avoid exposed wiring or terminals on the power tool itself. As such, the power tool may be better suited for harsh and hazardous conditions by avoiding potentially exposed electrical contacts, such as between a removable battery and a battery docking port on the power tool. Further, an operator using the inductive power supply backpack may quickly swap between a variety of inductively powered power tools without having to remove and reinstall batteries between the different power tools. This, in turn, can enable faster and more streamlined transitions between power tools.

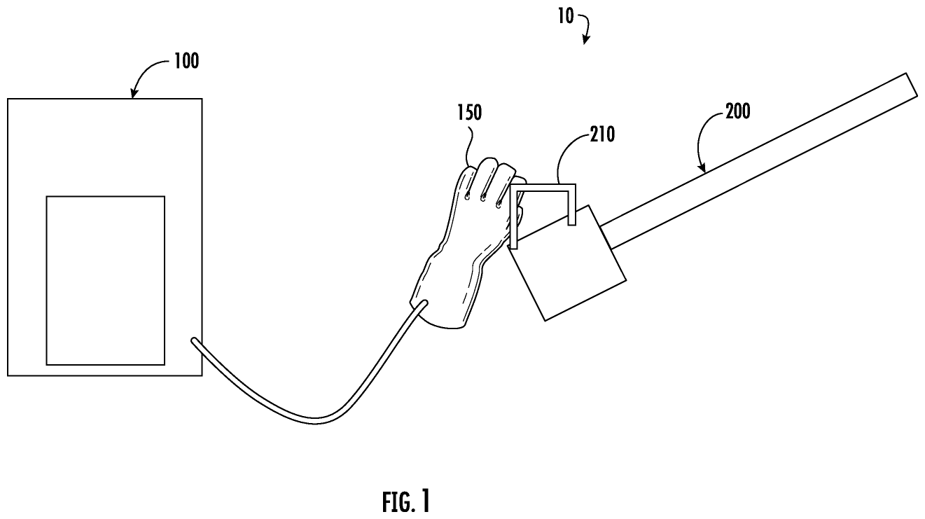

Referring now to the drawings, FIG. 1 illustrates an inductively powered power tool system 10 according to exemplary embodiments disclosed herein. The inductively powered power tool system 10 generally includes an inductive power supply backpack 100 and an inductively powered power tool 200. The inductive power supply backpack 100 includes a wearable transmitter having a transmittal coil (not shown). The wearable transmitter refers to a device that an operator can wear while operating a power tool. For illustrative purposes, an exemplary wearable transmitter as illustrated and described herein as a power glove 150 having a transmittal coil (not shown). Likewise, the inductively powered power tool 200 includes a tool handle 210 having a receiver coil (not shown).

An operator may thereby wear the inductive power supply backpack 100, slip on the power glove 150, and pick up the inductively powered power tool 200 via the tool handle 210 while still wearing the power glove 150. The transmittal coil in the power glove 150 can inductively couple with the receiving coil in the tool handle 210 to provide inductive power from the inductive power supply backpack 100 to the inductively powered power tool 200. The operator can thereby selectively grab and operate one or more inductively powered power tools 200 without the need for plugging in the individual power tools to an outlet, charging and/or installing one or more batteries in the power tools, or operating a gas powered motor on the power tools.

Specific discussion to the individual components of the inductively powered power tool system 10, and their interoperability, will be presented with respect to the additional figures presented herein.

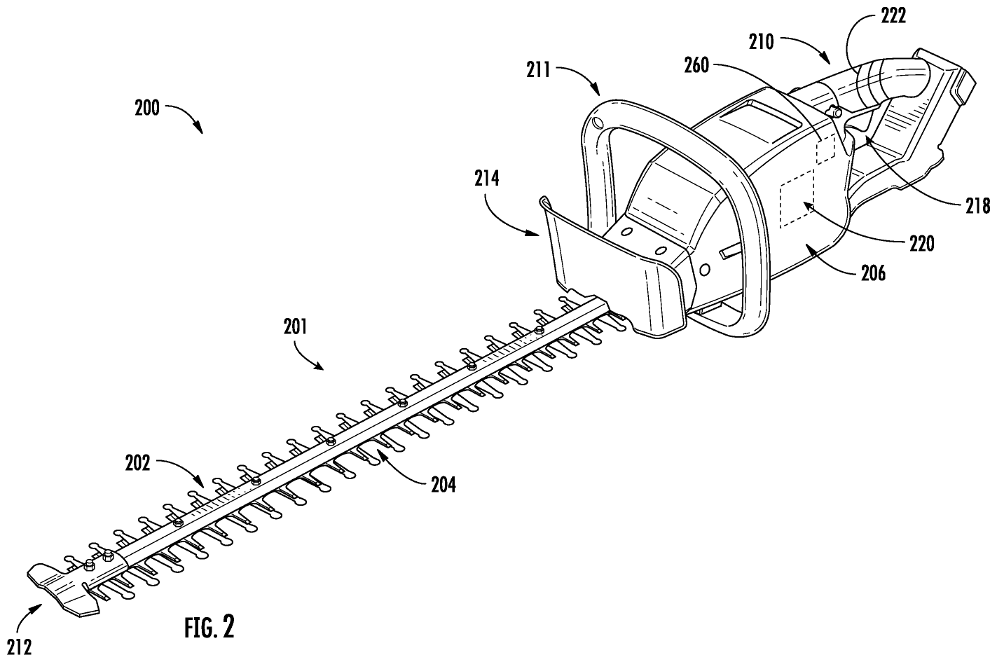

FIG. 2 illustrates an inductively powered power tool 200 according to exemplary embodiments disclosed herein, such as for use in the inductively powered power tool system 10 presented in FIG. 1. The inductively powered power tool 200 may have no direct physical connection (e.g., straps, mounts, plugs, wires, etc.) with the inductive power supply backpack (FIG. 1) so that an operator is able to move the inductively powered power tool 200 without physical constraint from the inductive power supply backpack. As illustrated in in FIG. 2, the inductively powered power tool 200 generally includes a tool handle 210, a working implement 240, and a drive unit 260. The drive unit 260 can be configured to drive the working implement 240 during operation of the inductively powered power tool 200.

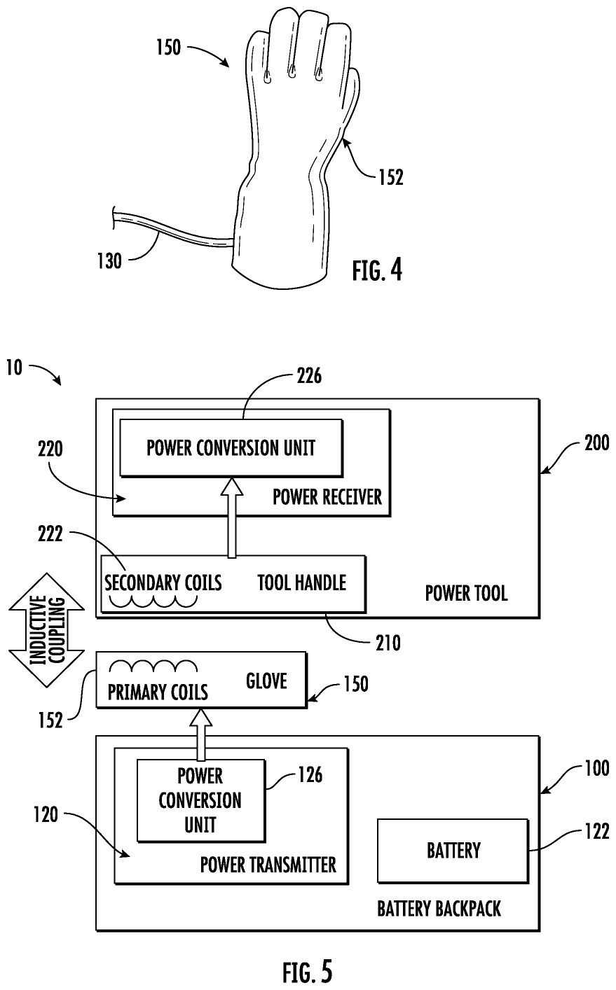

The inductively powered power tool 200 further includes a power receiver system 220. The power receiver system 220 is configured to inductively receive power from a power transmitter system of the inductive power supply backpack (FIG. 1). For instance, in some embodiments, the tool handle 210 of the inductively powered power tool 200 can include a receiver coil 222. As will be appreciated herein, the receiver coil 222 can inductively couple with a transmitter coil of a power glove (FIG. 4) or other wearable transmitter to provide inductive power to the inductively powered power tool 200 when an operator is holding the inductively powered power tool 200 by the tool handle 210.

By way of non-limiting example, the inductively powered power tool 200 can be a hedge trimmer 201 such as that illustrated in FIG. 2. The hedge trimmer 201 generally includes reciprocating cutting implements 202 and 204. The cutting implements 202 and 204 include blades or “teeth” which, when the implements are reciprocated, cause the blades to cut into material, such as branches of hedges. The hedge trimmer 201 may further include a housing 206. The cutting implements 202 and 204 may extend from the housing 206. The hedge trimmer 201 may include a tool handle 210. In certain embodiments, the hedge trimmer 201 may further include a secondary handle 211. The hedge trimmer 201 may further include a blade tip guard 212. The blade tip guard 212 may be configured to prevent the blades located furthest from the housing 206 from contact with objects (e.g., fences, siding, etc.). The hedge trimmer 201 may further include a blade guard 214. Blade guard 214 may be configured to stop flying debris from hitting the operator.

The hedge trimmer 201 may also include a drive unit 260 such as an electric motor, which drives a crankshaft (not illustrated). The crankshaft may be engaged with the cutting implements 202 and 204 such that rotation of the crankshaft causes the cutting implements 202 and 204 to reciprocate. The drive unit 260 receives power from the power receiver system 220, which itself, inductively receives power from the inductive power supply backpack (FIG. 1). In the depicted embodiment, the hedge trimmer 201 includes an actuator 218. The actuator 218 is disposed proximate to the tool handle 210. When depressed, the actuator 218 may engage the motive device to cause the cutting implements 202 and 204 to move. As the actuator 218 is depressed further, a speed of the motive device can increase from zero speed to a maximum speed. In this regard, the actuator 218 may variably affect the speed of the drive unit 260 between a stopped speed, which occurs when the actuator 218 is not depressed, and a maximum speed, which occurs when the actuator 218 is fully depressed.

However, while the inductively powered power tool 200 is presented as a hedge trimmer in FIG. 2, it should be appreciated that the inductively powered power tool 200 can alternatively or additionally be one of a variety of other types of power tools, such as, but not limited to, a string trimmer, a blower, an edger, a chainsaw, a lawn mower, a snow blower, or a pressure washer.

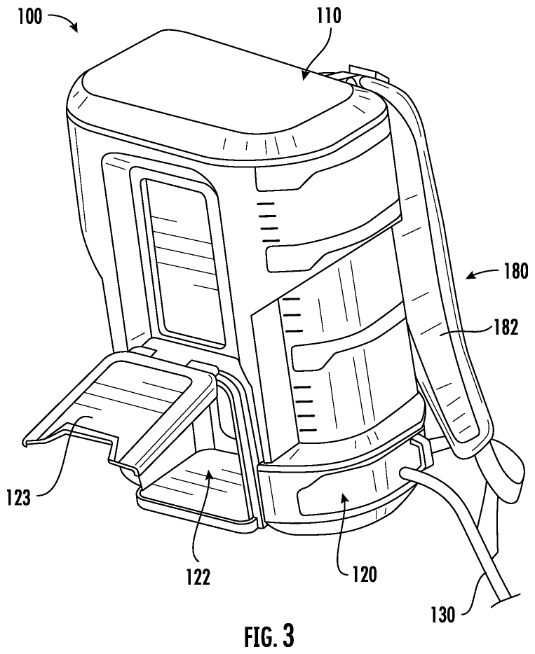

FIG. 3 illustrates an inductive power supply backpack 100 according to exemplary embodiments disclosed herein, such as for use in the inductively powered power tool system 10 presented in FIG. 1 by inductively powering the inductively powered power tool 200 presented in FIG. 2. As illustrated in in FIG. 3, the inductive power supply backpack 100 generally includes a body portion 110, a power transmitter system 120 and a power glove 150 (or other wearable transmitter).

The body portion 110 can define any physical structure operable to hold or support one or more components that facilitate inductive charging of the inductively powered power tool (FIG. 2). For instance, the body portion 110 can include a hard shell, a soft shell, a plurality of compartments fixed together, a mounting structure for mounting one or more components thereto, or any other suitable structure.

The power transmitter system 120 is configured to provide inductive power to one or more inductively powered power tools as disclosed herein. For instance, the power transmitter system 120 may generally include a power source 122, and a power transmitter (not shown). As will be discussed with respect to FIG. 5, the power transmitter can be disposed away from the body portion 110 of the inductive power supply backpack 100.

The power source 122 is configured to provide power to the power transmitter system 120 such that a current passes through a transmittal coil for inductive power transfer. In some embodiments, the power source 122 may comprise a battery compartment that can receive one or more batteries. The one or more batteries can be removable from the inductive power supply backpack 100. For instance, the one or more batteries may be capable of being charged on a standalone base station separate from the inductive power supply backpack 100. Once charged, the one or more batters may be inserted in one or more slots to provide a power source to the inductive power supply backpack.

Alternatively, or additionally, the power source 122 may be fixed to the inductive power supply backpack. For instance, the power source 122 may include one or more batteries that are fixed to the inductive power supply backpack 100 such that they can be removed without the use of tools and/or significant force. In such embodiments, the inductive power supply backpack 100 may be plugged into an outlet or charging source for charging the onboard one or more batteries. In some embodiments, the power supply may comprise a motor, such as a gas motor, that can generate power when running.

In some embodiments, the power source 122 used for the inductive power supply backpack 100 may include or incorporate a power source that is offboard and separate from the inductive power supply backpack 100. For instance, the power source 122 may include a socket or electrical cord that connects to an offboard electrical outlet. In such embodiments, the inductive power supply backpack 100 may be plugged into the power supply (e.g., outlet) when using the inductive power supply backpack 100 to inductively power an inductively powered power tool (FIG. 2). The inductive power supply backpack 100 may be plugged in via a retractable extension cord, a separate extension cord, or any other suitable device.

Moreover, the inductive power supply backpack 100 can include one more features to house or protect the power source 122. For instance, as illustrated in FIG. 3, the inductive power supply backpack 100 can include a power source compartment 123. The power source compartment 123 can include a fully or partially enclosed space for storing one or more power sources 122 such as batteries. The power source compartment 123 may transition between an open and closed state to facilitate the insertion and removal of power sources 122, when open, and otherwise protect the power sources 122 from the outside environment, when closed.

Still referring to FIG. 3, the inductive power supply backpack 100 may include one or more supplemental features to assist in the inductive powering of an inductively powered power tool (FIG. 2). For instance, as illustrated in FIG. 3, the inductive power supply backpack 100 can include a wearable carrying portion 180. The wearable carrying portion 180 can comprise any element or elements configured to assist an operator in carrying the inductive power supply backpack 100. For instance, as illustrated, the wearable carrying portion 180 can include one or more shoulder straps 182. In some embodiments, the wearable carrying portion 180 can include additional or alternative elements, such as hip straps, padding, braces, handles, or the like.

With additional reference to FIG. 4, a power glove 150 is illustrated serving as a wearable transmittal according to exemplary embodiments disclosed herein, such as for use with the inductive power supply backpack 100 presented in FIG. 3. The power glove 150 includes a transmittal coil 152 which is electrically connected to the inductive power supply backpack 100 via a power cable 130. That is, the power cable 130 facilitates the electrical connection between the power transmitter system 120 of the inductive power supply backpack 100 with the transmittal coil 152 of the power glove 150.

The power glove 150 is configured to be worn by an operator while holding a power tool. For example, in operation, the operator would slip on the power glove 150, pick up the inductively powered power tool (FIG. 2), and operate the inductively powered power tool via inductive powering provided through the transmittal coil 152. As such, the power glove 150 may be sized and shaped to both fit on the hand of an operator while also being able to wrap around a handle or other support structure of the inductively powered power tool (FIG. 2). In some embodiments, such as that illustrated in FIG. 4, the power glove 150 may be configured to completely surround the hand and all five fingers. However, in some embodiments, the power glove 150 may only cover a portion of the hand, such as just a part of the palm of the hand. Moreover, other forms of wearable transmitters may be utilized in lieu of, or in addition to, the power glove 150. For example, the wearable transmitter can comprise a wristband, sleeve, brace, shirt, or other wearable article.

The transmittal coil 152 can be disposed in any suitable location on or in the power glove 150 to facilitate inductive coupling with a component gripped by the power glove 150. For instance, in some embodiments, the transmittal coil 152 can be embedded in the power glove 150 (e.g., between an interior surface of the power glove 150 that touches an operator's hand and an exterior surface of the power glove 155 that contacts a tool being held by the power glove 150). In some embodiments, the transmittal coil 152 can be disposed on an exterior surface of the power glove 150.

The power glove 150 can also include any suitable material for housing or supporting the transmittal coil 152 for providing inductive power therefrom. For instance, the power glove 150 can include electrically insulative material separating the interior of the power glove 150 from the transmittal coil 152, the power cable 130, or combinations thereof.

The power cable 130 thereby extends from a location on the inductive power supply backpack 100 to the power glove 150 while allowing for movement of the operator's hand. For instance, the power cord 130 may have a suitable length for the user to fully outstretch their hand so that the power cable 130 does not restrict their movement during operation of the inductively powered power tool (FIG. 2). In some embodiments, the power cable 130 may be spooled around one or more hooks about the body portion 110 of the inductive power supply backpack 100. In some embodiments, the power cable 130 may be retractable from the inductive power supply backpack 100.

The power cable 130 may be permanently connected or releasably connected to the power glove 150. For instance, the power cable 130 may be releasably connected to the power glove 150 such that a variety of different power gloves 150 can be connected thereto. Such embodiments allow for an operator to select a suitable size and configuration (e.g., right handed or left handed) for the power glove 150. In some embodiments, multiple power gloves 150 may be connected via one or more power cables 130. For instance, the inductive power supply backpack 100 may include a left handed power glove 150 and a right handed power glove 150, each of which are electrically connected to the power transmitter system 120 via respective power cables 130. Such embodiments can allow for inductive coupling at two different locations about the inductively powered power tool which can be used selectively or simultaneously. Alternatively, or additionally, such embodiments can allow for the operator to selectively switch which hand holds the inductively powered power tool while still providing inductive power thereto in either situation.

With reference to FIG. 5, a schematic diagram is illustrated for inductive coupling between the inductive power supply backpack 100 and the inductively powered power tool 200 in the inductively powered power tool system 10 according to exemplary embodiments disclosed herein.

The inductive power supply backpack 100 includes the power transmitter system 120 for supplying inductive power. The power transmitter system 120 can include a variety of components and configurations suitable for supplying inductive power. For instance, as illustrated in FIG. 5, the power transmitter system 120 can include the power source 122 (e.g., a battery) and a power conversion unit 126. The power conversion unit 126 can convert the power supplied from the power source 122 to a form suitable for inductive power transmission, such as converting the power from direct current (DC) to alternating current (AC), or otherwise adjusting frequency, phase, magnitude or combinations thereof of the power source. AC power is then passed through the transmittal coil 152 in the power glove 150 to create an oscillating magnetic field around the transmittal coil 152.

The inductively powered power tool 200 includes a complementary power receiver system 220 for receiving inductive power from the power transmitter system 120 of the inductive power supply backpack 100. The power receiver system 220 can include a variety of components and configurations suitable for receiving inductive power. For instance, as illustrated in FIG. 5, the power receiver system 220 can include a receiver coil 222 in the tool handle 210 of the inductively powered power tool 200. When present, the oscillating magnetic field from the transmittal coil 152 induces an alternating electromotive force that creates an alternating current in the receiver coil 222. The inductively powered power tool 200 can further include its own power conversion unit 226 such as for converting the AC created in the receiver coil 222 into a DC power output. The DC power output may then be used for powering the drive unit (FIG. 2) of the inductively powered power tool 200. As such, power inductively received by the inductively powered power tool 200 from the inductive power supply backpack 100 can be used to power a drive unit for operation of the inductively powered power tool 200.

In some embodiments, one or more control units may be incorporated in the inductive power supply backpack 100, the inductively powered power tool 200, or combinations thereof. The control units may be configured to control one or more operations (e.g., parameters) of the inductive power transfer, such as the input power into the transmittal coil 152, the output power from the receiver coil 222, or the operation of the inductively powered power tool 200 such as by controlling operation of its drive unit (FIG. 2). For instance, in some embodiments, operation of the inductively powered power tool 200 may be selectively controlled based, at least in part, on the presence of inductive coupling between the inductive power supply backpack 100 and the inductively powered power tool 200. In some embodiments, the control unit can be configured to control operation of the drive unit, such as operating the drive unit only when the transmittal coil 152 is inductively coupled with the receiver coil 222. Additionally, or alternatively, the control unit can be configured to cease operation of the drive unit when inductive coupling between the transmittal coil 152 and the receiver coil 222 is broken. Such embodiments may provide an additional safeguard to unintended operation of the inductively powered power tool 200 when the operator is not, or is no longer, holding the inductively powered power tool 200 by the tool handle 210.

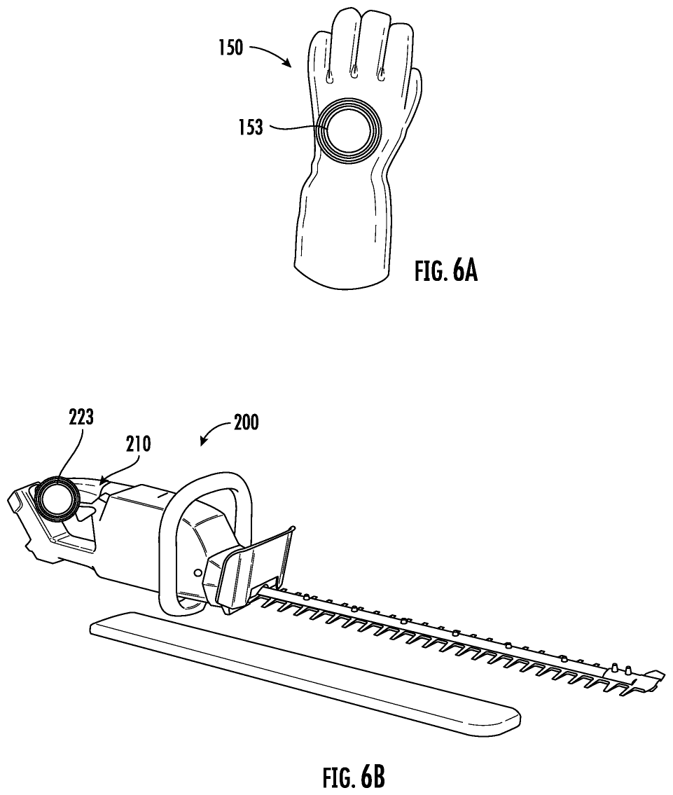

Various configurations may be utilized between the inductive power supply backpack 100 and the inductively powered power tool 200 to facilitate inductive powering therebetween. FIGS. 6A and 6B illustrate one exemplary configuration for the power glove 150 and the tool handle 210. Specifically, the power glove 150 includes a first configuration of a transmittal coil 153. The transmittal coil 153 of the first configuration has a substantially flat and circular coil configuration. For instance, the transmittal coil 153 can be disposed in the palm of the power glove 150 such that it is close to the tool handle 210 when the power glove 150 is used to grip the tool handle 210.

The inductively powered power tool 200 includes the tool handle 210 having a first configuration of a receiver coil 223. Complimentary to the transmittal coil 153, the receiver coil 223 can also have a substantially flat and circular coil configuration. For instance, the receiver coil 223 can be configured at or near the outer surface of the tool handle 210 and positioned so that it substantially aligns with the palm of the power glove 150 when gripping the tool handle 210. As such, the transmittal coil 153 and the receiver coil 223 can have a substantially close and aligned spatial relationship which can, in turn, improve power transfer efficiency during inductive coupling.

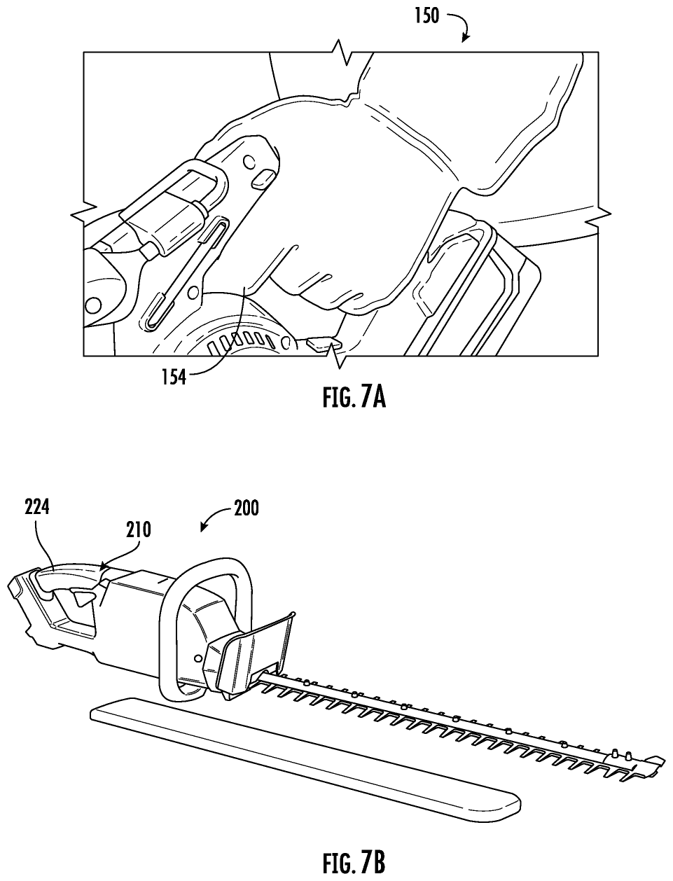

FIGS. 7A and 7B illustrate another exemplary configuration for the power glove 150 and the tool handle 210. Specifically, the power glove 150 includes a second configuration of a transmittal coil 154. The transmittal coil 154 of the second configuration has a wrapped or linear configuration in one or more different areas of the power glove 150. For instance, the transmittal coil 154 can be disposed in the fingers of the power glove 150 such that gripping motion of the power glove 150 brings the transmittal coil 154 closer to and partially surrounding the tool handle 210.

The inductively powered power tool 200 includes the tool handle 210 having a second configuration of a receiver coil 224. Complimentary to the transmittal coil 154, the receiver coil 224 can be a wrapped or linear configuration in the tool handle 210. For instance, the receiver coil 224 can be configured to extend along all or part the tool handle 210, potentially including forming a circular configuration as illustrated in FIG. 7B. As such, the transmittal coil 154 and the receiver coil 224 can have a substantially close and aligned spatial relationship wherever the power glove 150 grips the tool handle 210 which can, in turn, improve power transfer efficiency during inductive coupling while also providing positional flexibility to the operator.

The inductively powered power tool system 10 can utilize one or more alignment features between the power glove 150, the tool handle 210 or other suitable components to facilitate strong and consistent alignment between the transmittal coil 152 and the receiver coil 222. Strong alignment between the two elements enables higher power transfer thresholds and efficiency. For instance, the tool handle 210 may be contoured in such a way to provide mating or nesting of the power glove 150 in a targeted location. In some embodiments, the tool handle 210, the power glove 150, or combinations thereof may include alignment indicia indicating where to place one component with respect to the other.

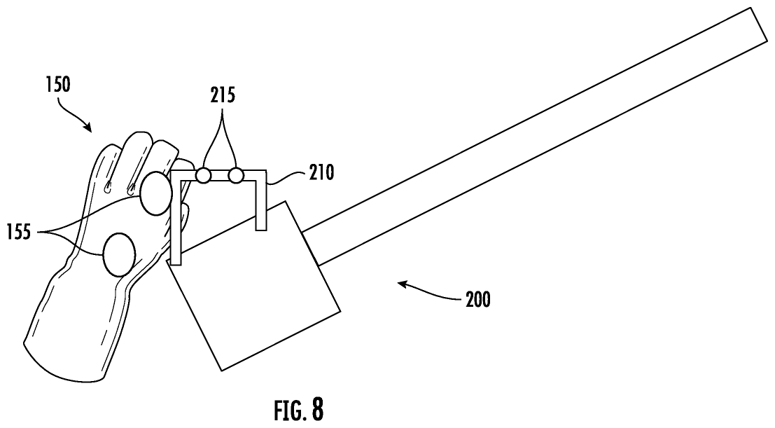

FIG. 8 illustrates an exemplary alignment of the power glove 150 with the tool handle 210 of the inductively powered power tool 200 using magnets. For instance, the power glove 150 includes one or more alignment magnets 155. The one or more alignment magnets 155 can be disposed at one or more locations of the power glove 150 that contact the tool handle 210. Additionally, or alternatively, the tool handle 210 can include one or more positioning magnets 215. The one or more positioning magnets 215 can be disposed at one or more locations of the tool handle 210 to help guide and softly lock the power glove 150 in place on the tool handle 210. As used herein, softly lock refers to a magnetic force that biases the power glove 150 to a certain location on the tool handle 210, but with a low enough force that an operator may overcome the bias under their own power and pull the power glove 150 away from the tool handle 210 when desired. In some embodiments, both alignment magnets 155 in the power glove 150 and positioning magnets 215 in the tool handle 210 can be used to provide complimentary alignment between the two components. That is, the alignment magnets 155 may be magnetically attracted to the positioning magnets 215 to help pull the power glove into a targeted location on the tool handle 210, such as one where the transmittal coil and receiver coil (not shown) are closely adjacent and aligned.

While exemplary embodiments are disclosed herein to facilitate inductive coupling between inductive power supply backpacks and inductively powered power tools, it should be appreciated that further configurations may also be realized within the scope of this disclosure. For instance, additional or alternative inductive coupling systems, such as having additional or alternative components may be utilized to provide inductive power to inductively powered power tools. Likewise, additional or alternative configurations of transmittal coils, receiver coils, alignment mechanisms, and other inductive coupling features, and combinations thereof, may also be incorporated within the inductively powered power tool systems disclosed herein.

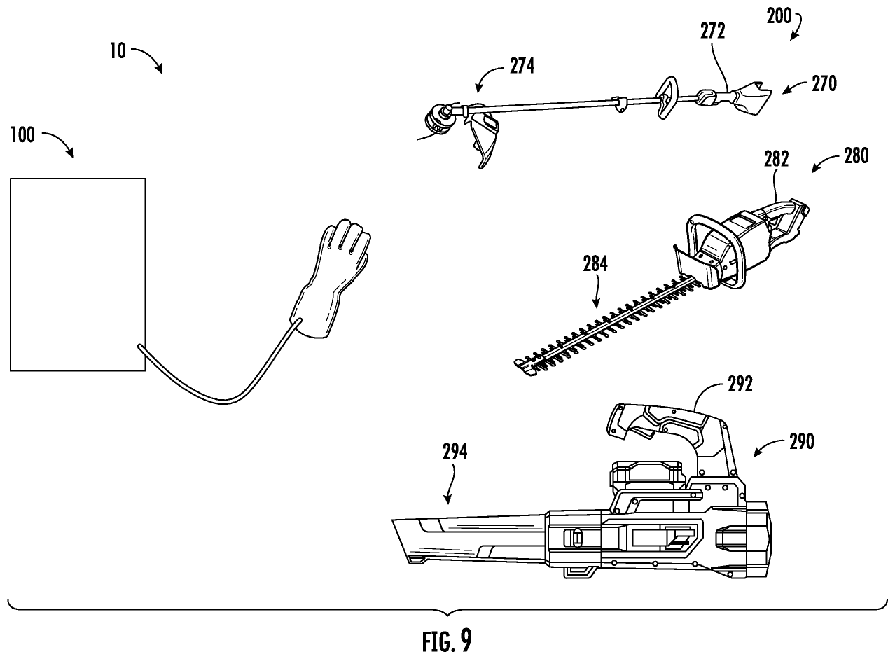

FIG. 9 illustrates the inductively powered power tool system 10 according to exemplary embodiments disclosed herein that can be used with a plurality of inductively powered power tools 200, such as a plurality of different inductively powered power tools 200.

The inductively powered power tool system 10 includes the inductive power supply backpack 100 in accordance with one or more of the embodiments disclosed herein. For instance, the inductive power supply backpack 100 includes the power source 122 and the power transmitter system 120 configured to inductively transfer power from the power source 122 via the transmittal coil 152. The inductive power supply backpack 100 further includes the power glove 150 wherein the transmittal coil 152 is disposed in and/or on the power glove 150.

The power glove 150 and the transmittal coil 152 can be configured to grab and power a plurality of inductively powered power tools 200, including a plurality of different types of inductively powered power tools 200. For instance, the plurality of inductively powered power tools 200 can include a first inductively powered power tool 270, a second inductively powered power tool 280, and a third inductively powered power tool 290. The first inductively powered power tool 270 can include a first handle 272 and a first working implement 274. The second inductively powered power tool 280 can include a second handle 282 and a second working implement 284. The third inductively powered power tool 290 can include a third handle 292 and a third working implement 294. The same power glove 150 can be used to grab any one of the first handle 272, second handle 282, or third handle 292 and provide inductive power thereto. Thus, the same inductive power supply backpack can be used to inductively power a plurality of inductively powered power tools 200 depending on which of the plurality are held by the power glove 150.

In some embodiments, the plurality of inductively powered power tools 200 can include different types of power tools. For instance, the first working implement 274, the second working implement 284, and the third working implement 294 of the respective first inductively powered power tool 270, the second inductively powered power tool 280, and the third inductively powered power tool 290 can each be different. In some embodiments, such as that illustrated in FIG. 9, the first inductively powered power tool 270 can be a line trimmer wherein the first working implement 274 is a rotary head for spinning a trimmer line. The second inductively powered power tool 280 can be a hedge trimmer (such as the one presented herein) wherein the second working implement 284 is one or more reciprocating blades. The third inductively powered power tool 290 can be a blower wherein the third working implement 294 is a blower fan.

By providing an inductive power supply backpack 100 with a power glove 150 that is universally configured to provide inductive power to a plurality of different inductively powered power tools 200, an operator may seamlessly switch between different power tools without having to exchange batteries, adjust power supplies, or stop/start individual motors. Moreover, once one inductively powered power tool is set down in favor of another, the retired inductively powered power tool is not at risk of accidental or unwanted operation since the power supply is removed. The inductively powered power tool systems disclosed herein thereby enable faster, safer, and more convenient operation of power tools through the use of inductive power between the power glove and the handles of the inductively powered power tools.

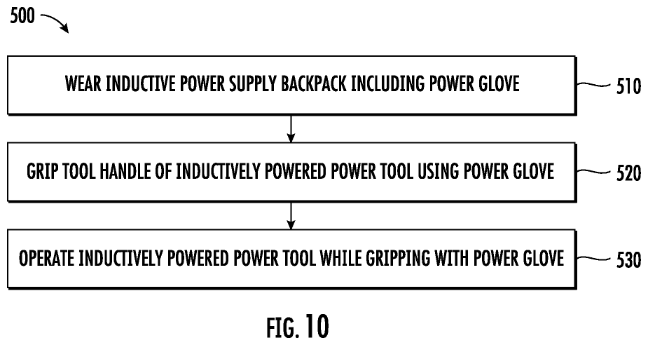

FIG. 10 illustrates an exemplary method 500 for operating an inductively powered power tool. The method 500 includes wearing an inductive power supply backpack in step 510. As disclosed herein, the inductive power supply backpack can include a power source, a power transmitter system configured to inductively transfer power from the power source via a transmittal coil, and a power glove that comprises the transmittal coil.

The method 500 further includes gripping a tool handle of the inductively powered power tool using the power glove in step 520. As disclosed herein, gripping the tool handle with the power glove can inductively couple the transmittal coil in the power glove with a receiver coil int he tool handle to inductively transfer power therebetween. The method 500 further includes operating the inductively powered power tool while the handle is gripped by the power glove in step 530. As disclosed herein, the inductively powered power tool can remain inductively powered while the operator grips the tool handle. While the method 500 is illustrated and described with an power glove, it should be appreciated that additional or alternative exemplary wearable transmitters may also be used in the method 500.

Further aspects of the invention are provided by one or more of the following embodiments:

An inductive power supply backpack comprising a body portion comprising a power source; a power transmitter system configured to inductively transfer power from the power source via a transmittal coil; and a wearable transmitter, wherein the wearable transmitter comprises the transmittal coil.

The inductive power supply backpack of any one or more of the embodiments disclosed herein, wherein the wearable transmitter comprises a power glove.

The inductive power supply backpack of any one or more of the embodiments disclosed herein, wherein the power glove comprises one or more alignment magnets.

The inductive power supply backpack of any one or more of the embodiments disclosed herein, wherein the transmittal coil is embedded in the power glove.

The inductive power supply backpack of any one or more of the embodiments disclosed herein, wherein the transmittal coil is disposed on an exterior surface of the power glove.

The inductive power supply backpack of any one or more of the embodiments disclosed herein, wherein the power transmitter system is configured to inductively transfer power from the power source to a power receiver system of a power tool.

The inductive power supply backpack of any one or more of the embodiments disclosed herein, wherein the power tool has no direct physical connection to the inductive power supply backpack.

The inductive power supply backpack of any one or more of the embodiments disclosed herein, further comprising a power cable electrically connecting the wearable transmitter to the body portion.

The inductive power supply backpack of any one or more of the embodiments disclosed herein, wherein the power source comprises a compartment configured to selectively receive a removable battery.

The inductive power supply backpack of any one or more of the embodiments disclosed herein, further comprising a wearable carrying portion attached to the body portion.

The inductive power supply backpack of any one or more of the embodiments disclosed herein, wherein the wearable carrying portion comprises one or more shoulder straps.

An inductively powered power tool system comprising an inductive power supply backpack comprising a power source; a power transmitter system configured to inductively transfer power from the power source via a transmittal coil; and a power glove, wherein power glove comprises the transmittal coil. The inductively powered power tool system further comprises an inductively powered power tool comprising a power receiver system configured to inductively receive power from the power transmitter system; a working implement; and a drive unit, configured to drive the working implement using power inductively received by the power receiver system from the power transmitter system.

The inductively powered power tool system of any one or more of the embodiments disclosed herein, wherein the inductively powered power tool further comprises a tool handle configured to receive the power glove when worn by an operator.

The inductively powered power tool system of any one or more of the embodiments disclosed herein, wherein the tool handle comprises a receiver coil that aligns with the transmitter coil of the power glove when the tool handle receives the power glove.

The inductively powered power tool system of any one or more of the embodiments disclosed herein, wherein the power glove comprises one or more alignment magnets.

The inductively powered power tool system of any one or more of the embodiments disclosed herein, wherein the tool handle comprises one or more positioning magnets, and wherein the one or more alignment magnets are magnetically attracted to the one or more positioning magnets.

The inductively powered power tool system of any one or more of the embodiments disclosed herein, wherein the inductively powered power tool further comprises a control unit configured to control operation of the drive unit.

The inductively powered power tool system of any one or more of the embodiments disclosed herein, wherein the control unit is configured to enable operation of the drive unit when the transmittal coil is inductively coupled with a receiver coil in a tool handle of the inductively powered power tool.

The inductively powered power tool system of any one or more of the embodiments disclosed herein, wherein the control unit is configured to cease operation of the drive unit when inductive coupling between the transmittal coil and the receiver coil is broken.

The inductively powered power tool system of any one or more of the embodiments disclosed herein, wherein the inductively powered power tool comprises a hedge trimmer.

The inductively powered power tool system of any one or more of the embodiments disclosed herein, wherein the inductively powered power tool comprises a string trimmer.

The inductively powered power tool system of any one or more of the embodiments disclosed herein, wherein the inductively powered power tool comprises a blower.

The inductively powered power tool system of any one or more of the embodiments disclosed herein, wherein the inductively powered power tool comprises a chainsaw.

The inductively powered power tool system of any one or more of the embodiments disclosed herein, wherein the inductively powered power tool comprises a lawn mower.

The inductively powered power tool system of any one or more of the embodiments disclosed herein, wherein the inductively powered power tool comprises a snow blower.

An inductively powered power tool system comprising an inductive power supply backpack comprising a power source; a power transmitter system configured to inductively transfer power from the power source via a transmittal coil; and a power glove, wherein the power glove comprises the transmittal coil. The inductively powered power tool system further comprises a plurality of inductively powered power tools, wherein each of the plurality of inductively powered power tools comprises a power receiver system configured to inductively receive power from the power transmitter system; a working implement; and a drive unit, configured to drive the working implement using power inductively received by the power receiver system from the power transmitter system.

The inductively powered power tool system of any one or more of the embodiments disclosed herein, wherein a first inductively powered power tool comprises a first type of working implement, and wherein a second inductively powered power tool comprises a second type of working implement different than the first type of working implement.

A method for operating an inductively powered power tool, the method comprising wearing an inductive power supply backpack comprising a power source; a power transmitter system configured to inductively transfer power from the power source via a transmittal coil; and a power glove, wherein the power glove comprises the transmittal coil. The method further comprises gripping a tool handle of the inductively powered power tool using the power glove; and operating the inductively powered power tool while the tool handle is gripped by the power glove.

The method of any one or more of the embodiments disclosed herein, wherein the inductively powered power tool comprises a power receiver system configured to inductively receive power from the power transmitter system; a working implement; and a drive unit, configured to drive the working implement using power received from the power transmitter system.

A system of one or more embodiments disclosed herein.

A power tool of one or more embodiments disclosed herein.

A control unit of one or more embodiments disclosed herein.

A method of one or more embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An inductive power supply backpack comprising:
a body portion comprising a power source;
a power transmitter system configured to inductively transfer power from the power source via a transmittal coil; and
a wearable transmitter, wherein the wearable transmitter comprises the transmittal coil.

2. The inductive power supply backpack of claim 1, wherein the wearable transmitter comprises a power glove.

3. The inductive power supply backpack of claim 2, wherein the power glove comprises one or more alignment magnets.

4. The inductive power supply backpack of claim 2, wherein the transmittal coil is embedded in the power glove.

5. The inductive power supply backpack of claim 2, wherein the transmittal coil is disposed on an exterior surface of the power glove.

6. The inductive power supply backpack of claim 1, wherein the power transmitter system is configured to inductively transfer power from the power source to a power receiver system of a power tool.

7. The inductive power supply backpack of claim 6, wherein the power tool has no direct physical connection to the inductive power supply backpack.

8. The inductive power supply backpack of claim 1, further comprising a power cable electrically connecting the wearable transmitter to the body portion.

9. The inductive power supply backpack of claim 1, wherein the power source comprises a compartment configured to selectively receive a removable battery.

10. The inductive power supply backpack of claim 1, further comprising a wearable carrying portion attached to the body portion.

11. An inductively powered power tool system comprising:
an inductive power supply backpack comprising:
a power source;
a power transmitter system configured to inductively transfer power from the power source via a transmittal coil; and
a power glove, wherein power glove comprises the transmittal coil; and
an inductively powered power tool comprising:
a power receiver system configured to inductively receive power from the power transmitter system;
a working implement; and
a drive unit, configured to drive the working implement using power inductively received by the power receiver system from the power transmitter system.

12. The inductively powered power tool system of claim 11, wherein the inductively powered power tool further comprises a tool handle configured to receive the power glove when worn by an operator.

13. The inductively powered power tool system of claim 12, wherein the tool handle comprises a receiver coil that aligns with the transmitter coil of the power glove when the tool handle receives the power glove.

14. The inductively powered power tool system of claim 12, wherein the power glove comprises one or more alignment magnets.

15. The inductively powered power tool system of claim 14, wherein the tool handle comprises one or more positioning magnets, and wherein the one or more alignment magnets are magnetically attracted to the one or more positioning magnets.

16. The inductively powered power tool system of claim 11, wherein the inductively powered power tool further comprises a control unit configured to control operation of the drive unit.

17. The inductively powered power tool system of claim 16, wherein the control unit is configured to enable operation of the drive unit when the transmittal coil is inductively coupled with a receiver coil in a tool handle of the inductively powered power tool.

18. The inductively powered power tool system of claim 17, wherein the control unit is configured to cease operation of the drive unit when inductive coupling between the transmittal coil and the receiver coil is broken.

19. The inductively powered power tool system of claim 11, wherein the inductively powered power tool comprises one of a hedge trimmer, a string trimmer, a blower, a chainsaw, a lawn mower, or a snow blower.

20. A method for operating an inductively powered power tool, the method comprising:
wearing an inductive power supply backpack comprising:
a power source;
a power transmitter system configured to inductively transfer power from the power source via a transmittal coil; and
a power glove, wherein the power glove comprises the transmittal coil;
gripping a tool handle of the inductively powered power tool using the power glove; and
operating the inductively powered power tool while the tool handle is gripped by the power glove.
